(19) United States
(12) Patent Application Publication
(10) Pub. No.: US 2026/0327481 A1
(43) Pub. Date: Oct. 22, 2026

(54) METHOD FOR PRODUCING WATER-SOLUBLE QUANTUM DOTS, AND WATER-SOLUBLE QUANTUM DOTS

(71) Applicant: Nippon Chemical Industrial Co., Ltd., Tokyo (JP)

(72) Inventors: Kazuhiro Nakatsui, Tokyo (JP); Tomo Sakanoue, Tokyo (JP)

(73) Assignee: Nippon Chemical Industrial Co., Ltd., Tokyo (JP)

(21) Appl. No.: 19/491,135

(22) PCT Filed: Jun. 11, 2024
(86) PCT No.: PCT/JP2024/021119

§ 371 Date: Dec. 8, 2025

(30) Foreign Application Priority Data
Jun. 12, 2023 (JP) 2023-096240

(51) Int. Cl. C09K 11/02; B82Y 20/00; B82Y 40/00; C09K 11/08; C09K 11/88

(52) U.S. Cl. CPC C09K 11/025; C09K 11/0883; C09K 11/883; B82Y 20/00; B82Y 40/00

(57) ABSTRACT

Provided are a method for producing water-soluble quantum dots which exhibit excellent quantum yield and have a narrow FWHM emission spectrum, and water-soluble quantum dots obtained thereby. That is, the method includes: adding hydrophilic ligands to a hydrophobic quantum dot dispersion to exchange ligands bound to surfaces of quantum dots with the hydrophilic ligands, thereby obtaining hydrophilic quantum dots; dispersing the hydrophilic quantum dots in an aqueous solvent to obtain an aqueous solvent dispersion of the hydrophilic quantum dots; adding a surface treatment agent to the aqueous solvent dispersion to perform surface treatment of the hydrophilic quantum dots in the aqueous solvent, thereby obtaining an aqueous solvent dispersion of surface-treated hydrophilic quantum dots; and adding a shell-forming agent to the aqueous solvent dispersion of surface-treated hydrophilic quantum dots to form shells on the surfaces of surface-treated hydrophilic quantum dots, thereby obtaining an aqueous solvent dispersion of water-soluble quantum dots.

### TECHNICAL FIELD

The present invention relates to a method for producing water-soluble quantum dots and the water-soluble quantum dots obtained using the above method of production.

### BACKGROUND ART

In recent years, development of quantum dots as light emitting materials has progressed. As typical quantum dots, cadmium-based quantum dots such as CdSe, CdTe, and CdS have been developed from the viewpoint of excellent emission properties, etc. Due to high toxicity and environmental load of cadmium, cadmium-free quantum dots such as InP, CuInS₂, and ZnTeSe are expected to be developed.

Utilizing these excellent emission properties, a method is employed to measure substances contained in living organisms such as proteins, viruses, and nucleic acids using molecular recognition bodies in which molecular recognition substances are conjugated to marker substances like phosphors. Here, to use quantum dots as marker substances within living organisms, it is necessary to coat quantum dot surfaces with water-soluble ligands to make the quantum dots water-soluble.

As a method for making quantum dots water-soluble by coating their surfaces with water-soluble ligands, for example, Patent Literature 1 describes, in Examples, an embodiment where InP quantum dots were contacted with zinc acetate and mercaptoacetic acid in an aqueous solvent, to obtain water-soluble quantum dots having an InP/ZnS core-shell structure modified by mercaptoacetic acid as ligands. In addition, Patent Literature 2 also describes, in Examples, an embodiment of water-soluble InP/ZnS core-shell quantum dots, and as its preparation method, indium chloride, zinc chloride, tris(diethylamino)phosphine, and sodium propanesulfonate are reacted in an amine, and then mercaptopropionic acid is added to obtain the InP/ZnS core-shell quantum dots coordinated with mercaptopropionic acid, followed by dispersing them in water.

In general, it is known that water-soluble quantum dots significantly reduce quantum yield and degrade emission properties such as broadening the full width at half maximum (hereinafter, also referred to as “FWHM”) of an emission spectrum. It is thought that this occurs because ligand exchange during water-solubilization creates defects on the quantum dot surfaces. In the above Patent Literature, it is feared that ligand exchange with a compound containing a mercapto group as the water-soluble ligand may result in defects on the quantum dot surfaces, and degradation of emission properties.

With respect to this problem, Patent Literature 3 describes that, to obtain water-soluble quantum dots with high brightness and stability, ZnS shell layers can be grown while passivating defects on the quantum dot surfaces with zinc by adding a mixed aqueous solution of zinc chloride and mercaptopropionic acid after ligand exchange with mercaptopropionic acid, thereby enabling excellent emission properties.

### CITATION LIST

### Patent Literature

Patent Literature 1: Chinese Patent Laid-Open No. 102031111
Patent Literature 2: Chinese Patent Laid-Open No. 114136934
Patent Literature 3: Chinese Patent Laid-Open No. 114891508

### SUMMARY OF INVENTION

### Technical Problem

As described in the above Patent Literature 3, excellent emission properties can be given even in water by forming shells while passivating defects generated on the quantum dot surfaces during ligand exchange, but it is difficult to achieve emission properties equivalent to or better than those in an organic solvent, which necessitates further investigation.

Accordingly, it is an object of the present invention to provide a method for producing water-soluble quantum dots which exhibit excellent quantum yield and a narrow FWHM emission spectrum in an aqueous solvent such as water, and to provide water-soluble quantum dots obtained using the above method.

### Solution to Problem

As a result of intensive studies for solving the above problems, the present inventors have found that when ligand-exchanged quantum dots were surface-treated in an aqueous solvent to repair defects on the quantum dot surfaces and then form shells, even the FWHM of the water-soluble quantum dots was equivalent to that of quantum dots obtained in an organic solvent, to suppress the decrease in quantum yield, and arrived at completing the present invention.

Namely, the present invention provides a method for producing water-soluble quantum dots, the method including: a ligand exchange step of adding hydrophilic ligands to a hydrophobic quantum dot dispersion to exchange ligands bound to surfaces of quantum dots with the hydrophilic ligands, thereby obtaining hydrophilic quantum dots; a dispersion step of dispersing the hydrophilic quantum dots in an aqueous solvent to obtain an aqueous solvent dispersion of the hydrophilic quantum dots; a surface treatment step of adding a surface treatment agent to the aqueous solvent dispersion to perform surface treatment of the hydrophilic quantum dots in the aqueous solvent, thereby obtaining an aqueous solvent dispersion of surface-treated hydrophilic quantum dots; and a shell formation step of adding a shell-forming agent to the aqueous solvent dispersion of the surface-treated hydrophilic quantum dots to form shells on the surfaces of the surface-treated hydrophilic quantum dots, thereby obtaining an aqueous solvent dispersion of water-soluble quantum dots.

The present invention also provides water-soluble quantum dots wherein quantum yield of the water-soluble quantum dots obtained by replacing ligands bound to the surfaces of hydrophobic quantum dots with hydrophilic ligands is more than 0.8 with respect to quantum yield of the hydrophobic quantum dots.

### Advantageous Effect of Invention

According to the present invention, water-soluble quantum dots, which exhibit excellent quantum yield and a narrow FWHM emission spectrum in an aqueous solvent, can be produced industrially in a favorable manner.

### BRIEF DESCRIPTION OF DRAWINGS

FIG. 1 is an emission spectrum of an aqueous dispersion of water-soluble quantum dots obtained in Example 1.

FIG. 2 is an emission spectrum of an aqueous dispersion of water-soluble quantum dots obtained in Example 2.

FIG. 3 is an emission spectrum of an aqueous dispersion of water-soluble quantum dots obtained in Example 3.

### DESCRIPTION OF EMBODIMENTS

### <Hydrophobic Quantum Dot Dispersion>

A hydrophobic quantum dot dispersion used in the present invention is one in which hydrophobic quantum dots are dispersed in a solvent, wherein the hydrophobic quantum dots are quantum dots with hydrophobic ligands on their surfaces. The hydrophobic quantum dot dispersion may be obtained through a reaction of raw material compounds composed of elements that constitute the hydrophobic quantum dots in a solvent, or it may be prepared by dispersing commercially available hydrophobic quantum dots in a solvent.

The solvent for the above dispersion is preferably a nonpolar organic solvent, and more preferably a solvent composed of aliphatic hydrocarbons. Examples of aliphatic hydrocarbons include saturated hydrocarbons such as n-hexane, n-heptane, n-octane, n-nonane, n-decane, n-dodecane, n-hexadecane, and n-octadecane; and unsaturated aliphatic hydrocarbons such as 1-undecene, 1-dodecene, 1-tetradecene, 1-hexadecene, and 1-octadecene. The aliphatic hydrocarbon used as a solvent may be a single type or a mixture of two or more types.

Examples of quantum dots constituting the above hydrophobic quantum dots include cadmium-based quantum dots such as CdSe, CdTe, and CdS; and cadmium-free quantum dots such as InP, CuInS, and ZnTeSe. In the present invention, preferred are quantum dots having a core-shell structure with a shell formed on a surface of a core, and particularly preferred are quantum dots having a core-shell structure in which the core includes an InP-based quantum dot obtained by reaction of at least a phosphorus source and an indium source, and in which the shell includes a coating compound other than an InP-based compound.

Examples of hydrophobic ligands constituting the above hydrophobic quantum dots include carboxylic acid derivatives, phosphine derivatives, amine derivatives, and phosphonic acids.

Examples of the above carboxylic acid derivatives preferably include those with straight-chain alkyl groups having 2 to 24 carbon atoms in the molecule. Specific examples of the carboxylic acids with straight-chain alkyl groups having 2 to 24 carbon atoms include capric acid, lauric acid, myristic acid, palmitic acid, stearic acid, arachidic acid, behenic acid, elaidic acid, oleic acid, linolenic acid, and erucic acid. Among these, those with alkyl groups having 12 to 20 carbon atoms in the molecule are particularly preferable from the viewpoint of improving the quality of the hydrophobic quantum dots to be obtained, and oleic acid is most preferable.

The above phosphine derivatives are preferably primary to tertiary alkyl phosphines and preferably include those with straight-chain alkyl groups having 2 to 18 carbon atoms in the molecule. The alkyl groups in the molecule may be identical or different. Specific examples of the alkyl phosphines with straight-chain alkyl groups having 2 to 18 carbon atoms include monoethylphosphine, monobutylphosphine, monodecylphosphine, monohexylphosphine, monooctylphosphine, monododecylphosphine, monohexadecylphosphine, diethylphosphine, dibutylphosphine, didecylphosphine, dihexylphosphine, dioctylphosphine, didodecylphosphine, dihexadecylphosphine, triethylphosphine, tributylphosphine, tridecylphosphine, trihexylphosphine, trioctylphosphine, tridodecylphosphine, and trihexadecylphosphine. Among these, from the viewpoint of improving the quality of hydrophobic quantum dots to be obtained, those with alkyl groups having 4 to 12 carbon atoms in the molecule are particularly preferable; trialkyl phosphine is preferable; and trioctyl phosphine is most preferable.

The above amine derivatives are preferably primary to tertiary alkylamines and preferably include straight-chain alkylamines with alkyl groups having 2 to 18 carbon atoms in the molecule and aromatic alkylamines having 6 to 12 carbon atoms. The alkyl groups in the molecule may be identical or different. Specific examples of the alkylamines with straight-chain alkyl groups having 2 to 18 carbon atoms include monoethylamine, monobutylamine, monodecylamine, monohexylamine, monooctylamine, monododecylamine, monohexadecylamine, diethylamine, dibutylamine, didecylamine, dihexylamine, dioctylamine, didodecylamine, dihexadecylamine, triethylamine, tributylamine, tridecylamine, trihexylamine, trioctylamine, tridodecylamine, and trihexadecylamine. Specific examples of the aromatic alkylamines with alkyl groups having 6 to 12 carbon atoms include aniline, diphenylamine, triphenylamine, monobenzylamine, dibenzylamine, tribenzylamine, naphthylamine, dinaphthylamine, and trinaphthylamine.

In addition, the above phosphonic acids are preferably monoalkyl phosphonic acids with a straight-chain alkyl group having 2 to 18 carbon atoms in the molecule.

When the hydrophobic quantum dots used in the present invention have a core-shell structure, examples of the suitable coating compounds for the shell include AlN, AlP, Al₂O₃, GaN, GaP, Ga₂O₃, SiO₂, CdS, CdSe, CdSeS, CdTe, CdSeTe, CdTeS, ZnS, ZnSe, ZnSeS, ZnTe, ZnSeTe, ZnTeS, ZnO, ZnOS, ZnSeO, and ZnTeO. In the present invention, it is preferable that the coating compound be obtained at least by reaction with a zinc source.

The hydrophobic quantum dot dispersion used in the present invention can be prepared by a known method, for example, the method described in Japanese Patent laid-Open No. 2023-033157.

### <Ligand Exchange Step>

The ligand exchange reaction in the present invention is a step of adding hydrophilic ligands to a hydrophobic quantum dot dispersion to exchange ligands bound to surfaces of quantum dots with the hydrophilic ligands, thereby obtaining hydrophilic quantum dots.

Examples of the hydrophilic ligands include thiols, amine-containing thiols, amines, alcohols, thiol-containing alcohols, selenols, phosphites, phosphinic acids, phosphonic acids, phosphoric acids, phosphine oxides, phosphine sulfides, phosphine selenides, carboxylic acids, thiol-containing carboxylic acids, thio-carboxylic acids, thiono-carboxylic acids, dithio-carboxylic acids, sulfenic acids, sulfinic acids, and sulfonic acids. Among these, from the viewpoint of improving the stability and quantum yield of hydrophilic quantum dots, thiols, amine-containing thiols, amines, alcohols, thiol-containing alcohols, phosphonic acids, carboxylic acids, and thiol-containing carboxylic acids are preferable, and the thiol-containing carboxylic acids are particularly preferable.

Examples of the above thiol-containing carboxylic acids include thioglycolic acid, 2-mercaptopropionic acid, 3-mercaptopropionic acid, thiomalic acid, cysteine, acetylcysteine, homocysteine, and penicillamine. Among these, from the viewpoint of improving the water dispersibility and quantum yield of quantum dots, thioglycolic acid, 3-mercaptopropionic acid, cysteine, and acetylcysteine are preferable, and 3-mercaptopropionic acid is more preferable.

When adding hydrophilic ligands to a quantum dot dispersion, the temperature is preferably 0° C. or more and 350° C. or less, more preferably 20° C. or more and 300° C. or less, from the viewpoint of successfully promoting ligand exchange; and the processing time is preferably 1 minute or more and 600 minutes or less, and more preferably 5 minutes or more and 240 minutes or less. In addition, the amount of ligands added, which also depends on the type of ligands, is preferably 0.01 g/L or more and 100,000 g/L or less with respect to the reaction solution containing the quantum dots, and more preferably 0.1 g/L or more and 2,000 g/L or less.

When adding hydrophilic ligands to the quantum dot dispersion, the atmosphere is preferably a non-oxidizing atmosphere, such as an inert gas atmosphere, a reduced pressure atmosphere, or a vacuum atmosphere, from the viewpoint of preventing the denaturation of quantum dots and the formation of oxide byproducts. The above non-oxidizing atmosphere is preferably an inert gas atmosphere, such as nitrogen gas or argon gas, from the viewpoint of ease of operation.

Through the above step, a dispersion containing hydrophilic quantum dots is obtained.

Next, from the above dispersion containing the hydrophilic quantum dots, the hydrophilic quantum dots are separated. Examples of the separation method include general methods such as centrifugation, decantation, and suction filtration. At this time, to remove unwanted hydrophobic ligands, it is preferable that an operation in which solvent capable of dissolving the ligands is added, and the hydrophilic quantum dots are separated using centrifugation or the like, be repeated a few times.

Through the above step, hydrophilic quantum dots are obtained.

### <Dispersion Step>

The dispersion step in the present invention is a step of dispersing the above hydrophilic quantum dots in an aqueous solvent to obtain an aqueous solvent dispersion of the hydrophilic quantum dots.

The above aqueous solvent is not particularly limited if it is any water-soluble solvent, and examples include water, methanol, ethanol, 2-propanol, ethylene glycol, propylene glycol, acetone, acetonitrile, N-methylpyrrolidone, dimethylformamide, and tetrahydrofuran; however, water is preferable.

The above hydrophilic quantum dot aqueous solvent dispersion is obtained through dispersing the above hydrophilic quantum dots in the above aqueous solvent. Although the above hydrophilic quantum dots can be dispersed directly into the above aqueous solvent, when the hydrophilic ligands are thiol-containing carboxylic acids, for example, it is preferable that these be dispersed into the above aqueous solvent after reacting them with ammonia water or tetraethylammonium hydroxide, etc., and converting them into ammonium salt, from the viewpoint of obtaining a uniform dispersion.

In addition, the hydrophilic quantum dots may contain byproducts or unreacted impurities prior to the dispersion step, and therefore purification treatment may be applied. This purification treatment can be performed by adding an organic solvent such as methanol, ethanol, 2-propanol, acetone, acetonitrile, or tetrahydrofuran to the solution containing the hydrophilic quantum dots, to precipitate the hydrophilic quantum dots, separating the hydrophilic quantum dots from the solution containing impurities, and dispersing the separated hydrophilic quantum dots in an aqueous solvent. The separation of the impurity-containing solution from the hydrophilic quantum dots can be performed using operations such as centrifugation, decantation, or suction filtration.

Through the above step, an aqueous solvent dispersion of hydrophilic quantum dots is obtained.

### <Surface Treatment Step>

The surface treatment step in the present invention is a step of adding a surface treatment agent to the above aqueous solvent dispersion to perform surface treatment of hydrophilic quantum dots in the aqueous solvent, thereby obtaining an aqueous solvent dispersion of surface-treated hydrophilic quantum dots.

In the surface treatment step, defects formed on the quantum dot surfaces during the above ligand exchange step are repaired using a surface treatment agent in the aqueous solvent to stabilize the quantum dots and create uniform surfaces, enabling stable shell formation in the subsequent shell formation step. Consequently, the water-soluble quantum dots finally obtained in the present invention exhibit a FWHM equivalent to that of quantum dots obtained in organic solvents and suppress the decrease in quantum yield.

Examples of the above surface treatment agent include metal halides such as halides of Li, Na, K, Be, Mg, Ca, Sr, Cu, Ag, Au, Hg, In, Sn, Pb, Zn, Cd, Al, and Ga; hydrogen halides such as HF, HCl, HBr, and HI; nitrogen halides such as NF₃; halides of quaternary ammonium compounds and quaternary phosphonium compounds such as NR₄F and PR₄F (where R represents H, or a saturated, unsaturated, or aromatic hydrocarbon having 1 to 8 carbon atoms, which may be straight-chain or branched, and may be substituted with functional groups); carboxylic acids, phosphonic acids, sulfonic acids, and their acid halides; metal carboxylates, metal carbamates, metal thiocarboxylates, etc., containing a metal such as Li, Na, K, Be, Mg, Ca, Sr, Cu, Ag, Au, Hg, In, Sn, Pb, Zn, Cd, Al, and Ga. Among these, from the viewpoint of achieving an enhanced quantum yield, it is preferable that the above surface treatment agent be a metal halide and a metal carboxylate. Examples of the above metal halide include zinc fluoride, zinc chloride, zinc bromide, and zinc iodide; and the zinc chloride is particularly preferable. Examples of the above metal carboxylate include zinc acetate, zinc trifluoroacetate, zinc myristate, zinc oleate, and zinc benzoate; and the zinc acetate is particularly preferable.

The surface treatment of hydrophilic quantum dots can be performed by adding a surface treatment agent to the above hydrophilic quantum dot aqueous solvent dispersion. The surface treatment is preferably performed under conditions of preferably −20° C. or more and 200° C. or less, more preferably 0° C. or more and 150° C. or less, particularly 20° C. or more and 120° C. or less, and preferably 1 minute or more and 600 minutes or less, more preferably 5 minutes or more and 240 minutes or less, particularly 10 minutes or more and 120 minutes or less. The amount of surface treatment agent added, which also depends on the type of surface treatment agent, is preferably 0.01 g/L or more and 10,000 g/L or less with respect to the above hydrophilic quantum dot aqueous solvent dispersion, and more preferably 0.1 g/L or more and 1,000 g/L or less.

The atmosphere in the surface treatment step is preferably a non-oxidizing atmosphere, such as an inert gas atmosphere, a reduced pressure atmosphere, or a vacuum atmosphere, from the viewpoint of preventing the denaturation of quantum dots and the formation of oxide byproducts. The non-oxidizing atmosphere is preferably an inert gas atmosphere, such as nitrogen gas or argon gas, from the viewpoint of ease of operation.

Examples of the method for adding a surface treatment agent in the surface treatment step include a method for directly adding the surface treatment agent to the reaction solution, and a method for adding the surface treatment agent to the reaction solution in the state of dissolving or dispersing it in a solvent. When adding the surface treatment agent to the reaction solution in the state of dissolving or dispersing it in a solvent, the solvent is not particularly limited if it is a water-soluble solvent, and examples include water, methanol, ethanol, 2-propanol, ethylene glycol, propylene glycol, acetone, acetonitrile, N-methylpyrrolidone, dimethylformamide, and tetrahydrofuran; however, water is particularly preferable.

Through the above step, an aqueous solvent dispersion of surface-treated hydrophilic quantum dots is obtained.

### <Shell Formation Step>

The shell formation step in the present invention is a step of adding a shell-forming agent to an aqueous solvent dispersion of the above surface-treated hydrophilic quantum dots to form shells on the surfaces of the surface-treated hydrophilic quantum dots, thereby obtaining an aqueous solvent dispersion of water-soluble quantum dots.

The shell-forming agent is preferably a mixture of: at least one sulfur source selected from the group consisting of thiols, thiol-containing carboxylic acids, thioureas, thiocarbamates, thiocarbonates, thiocarboxylic acids, thionocarboxylic acids, dithiocarboxylic acids, phosphine sulfides, and sulfides of Li, Na, K, Be, Mg, Ca, and Sr; and zinc carboxylate, zinc nitrate, zinc sulfate, zinc hypochlorite, zinc chlorite, zinc chlorate, zinc perchlorate, zinc bromate, zinc iodate, zinc carbonate, zinc borate, zinc hypophosphite, zinc phosphite, zinc phosphate, zinc trifluoromethanesulfonate, or a halide of zinc.

Particularly from the viewpoint of enhancing quantum yield, it is preferably the mixture, of thiol-containing carboxylic acids as the sulfur source, and zinc carboxylate, zinc perchlorate, or a halide of zinc as the zinc source, and particularly preferably the mixture of thiol-containing carboxylic acids and a halide of zinc.

Examples of the above thiol-containing carboxylic acids include thioglycolic acid, 2-mercaptopropionic acid, 3-mercaptopropionic acid, thiomalic acid, cysteine, acetylcysteine, homocysteine, and penicillamine. Among these, from the viewpoint of the water dispersibility and quantum yield of quantum dots, thioglycolic acid, 3-mercaptopropionic acid, cysteine, and acetylcysteine are preferable, and 3-mercaptopropionic acid is more preferable.

As the above halide of zinc, zinc fluoride, zinc chloride, zinc bromide, and zinc iodide are preferable, and zinc chloride is particularly preferable.

Shell formation can be performed by adding a shell-forming agent to an aqueous solvent dispersion of the above surface-treated hydrophilic quantum dots. After adding the shell-forming agent, shells can be formed on the surfaces of the surface-treated hydrophilic quantum dots by performing the treatment, preferably at 30° C. or more and 200° C. or less, more preferably at 50° C. or more and 150° C. or less, particularly at 70° C. or more and 120° C. or less, for a duration of preferably 1 minute or more and 600 minutes of less, more preferably 5 minutes or more and 240 minutes or less, and particularly 10 minutes or more and 120 minutes or less.

The atmosphere during the shell formation step is preferably a non-oxidizing atmosphere, such as an inert gas atmosphere, a reduced pressure atmosphere, or a vacuum atmosphere, from the viewpoint of preventing the denaturation of quantum dots and the formation of oxide byproducts. The non-oxidizing atmosphere is preferably an inert gas atmosphere, such as nitrogen gas or argon gas, from the viewpoint of ease of operation.

Examples of the method for adding a shell-forming agent in the shell formation step include a method for directly adding the shell-forming agent to the reaction solution, and a method for adding the shell-forming agent to the reaction solution in the state of dissolving or dispersing it in a solvent. When adding the shell-forming agent to the reaction solution in the state of dissolving or dispersing it in a solvent, the solvent is not particularly limited if it is a water-soluble solvent, and examples include water, methanol, ethanol, 2-propanol, ethylene glycol, propylene glycol, acetone, acetonitrile, N-methylpyrrolidone, dimethylformamide, and tetrahydrofuran; however, water is particularly preferable.

Through the above step, an aqueous solvent dispersion of water-soluble quantum dots is obtained.

From the obtained aqueous solvent dispersion of water-soluble quantum dots, the water-soluble quantum dots can be separated using common methods such as centrifugation, decantation, and suction filtration. The obtained water-soluble quantum dots are dispersed in an aqueous solvent again and insoluble impurities are removed, obtaining an aqueous solvent dispersion of purified water-soluble quantum dots.

The water-soluble quantum dots obtained using the method of the present invention exhibit excellent emission properties even in an aqueous solvent, because the decrease in quantum yield from the hydrophobic quantum dots prior to water-solubilization is suppressed. Namely, when the ratio (B %/A %) of the quantum yield (B %) of the water-soluble quantum dots to the quantum yield (A %) of the quantum dots prior to water-solubilization is defined as a maintenance value of the quantum yield, the maintenance value is more than 0.8, preferably 0.82 or more, and therefore, this enables the quantum dots to be used in fields where hydrophobic quantum dots could not be employed, such as bioimaging with fluorescent probes.

### EXAMPLES

The present invention will be described in detail with reference to the following Examples, but the present invention is not limited thereto. The properties in Examples were measured using the following methods. (1) Emission spectrum, maximum fluorescence wavelength, full width at half maximum (FWHM), and quantum yield (PLQY) were measured using an absolute PL quantum yield measurement device (Quantaurus-QY, produced by Hamamatsu Photonics K.K.) on the resulting quantum dot aqueous dispersion under the measurement conditions of an excitation wavelength of 400 nm and a measurement wavelength of 200 to 950 nm.

(2) Maintenance value of quantum yield

It is calculated using the following formula:

(Maintenance Value of Quantum Yield)=(Quantum Yield of Water-Soluble Quantum Dots)/(Quantum Yield of Quantum Dots Obtained in Synthesis Example)

### [Synthesis Example 1] Synthesis of Green InP/ZnSe/ZnS Quantum Dots

To 14.25 g of 1-octadecene, 1.04 g of indium myristate, 0.31 g of zinc myristate, and 0.06 g of indium acetate were added, and the mixture was heated to 120° C. while stirring under reduced pressure and degassed for 1.5 hours. After degassing, the pressure was returned to atmospheric pressure using nitrogen gas, and the mixture was cooled to 40° C. to obtain a 1-octadecene solution of indium zinc myristate.

In the state that the obtained 1-octadecene solution of indium zinc myristate was held at 40° C. under a nitrogen atmosphere, 2.51 g of trioctylphosphine solution containing 10% by mass of tris(trimethylsilyl)phosphine was added, and held for 10 minutes, to allow it to cool naturally to 20° C. Thereby a yellow liquid containing an InP quantum dot precursor was obtained.

Then, the InP quantum dot precursor solution was heated to 250° C. to obtain an InP quantum dot reaction solution.

In a 200 mL reaction vessel, 7.54 g of zinc oleate, 4.09 g of zinc chloride, 5.40 g of trioctylphosphine selenide, 8.90 g of trioctylphosphine, 16.26 g of oleylamine, and 16.26 g of dioctylamine were mixed, and heated to 120° C. while stirring under reduced pressure and degassed for 30 minutes. After degassing, the pressure was returned to atmospheric pressure using nitrogen gas, and the mixture was heated to 180° C. under a nitrogen atmosphere; to the mixture, 18.17 g of the previously obtained InP quantum dot reaction solution was added, heated to 230° C., and held for 30 minutes; and then the mixture was further heated to 300° C. and held for 60 minutes, to obtain an oleylamine/dioctylamine dispersion of InP/ZnSe quantum dots with an InP core and ZnSe shell. After cooling the obtained dispersion to 240° C., 7.54 g of zinc oleate, 7.54 g of trioctylphosphine, and 4.35 g of trioctylphosphine sulfide were injected in the dispersion and held for 90 minutes, obtaining an oleylamine/dioctylamine dispersion of multi-shell type quantum dots with an InP core and layered ZnSe and ZnS shell.

After cooling the obtained dispersion to room temperature, 50 g of acetone was added to the dispersion and stirred, and the InP/ZnSe/ZnS quantum dots were collected as precipitates with centrifugation. The collected InP/ZnSe/ZnS quantum dots were suspended in 8.67 g of toluene to obtain a toluene dispersion of the InP/ZnSe/ZnS quantum dots. To this dispersion, 50 g of acetone was further added and stirred, and the InP/ZnSe/ZnS quantum dots were collected as precipitates with centrifugation. The collected InP/ZnSe/ZnS quantum dots were suspended in 7.03 g of octane to obtain an octane dispersion of purified InP/ZnSe/ZnS quantum dots. The results of measuring the emission properties of the resulting dispersion are shown in Table 1.

### [Synthesis Example 2] Synthesis of Orange InP/ZnSe/ZnS Quantum Dots

To 14.25 g of 1-octadecene, 1.43 g of indium myristate was added, and the mixture was heated to 120° C. while stirring under reduced pressure and degassed for 1.5 hours. After degassing, the pressure was returned to atmospheric pressure using nitrogen gas, and the mixture was cooled to 40° C. to obtain a 1-octadecene solution of indium myristate. In the state that the obtained 1-octadecene solution of indium myristate was held at 40° C. under a nitrogen atmosphere, 2.51 g of trioctylphosphine solution containing 10% by mass of tris(trimethylsilyl)phosphine was added, and held for 10 minutes, to allow it to cool naturally to 20° C. Thereby a yellow liquid containing an InP quantum dot precursor was obtained.

Then, the InP quantum dot precursor solution was heated to 280° C. to obtain an InP quantum dot reaction solution.

In a 200 mL reaction vessel, 7.54 g of zinc oleate, 4.09 g of zinc chloride, 5.40 g of trioctylphosphine selenide, 8.90 g of trioctylphosphine, 16.26 g of oleylamine, and 16.26 g of dioctylamine were mixed, and heated to 120° C. while stirring under reduced pressure and degassed for 30 minutes. After degassing, the pressure was returned to atmospheric pressure using nitrogen gas, and the mixture was heated to 180° C. under a nitrogen atmosphere; to the mixture, 18.17 g of the previously obtained InP quantum dot reaction solution was added, heated to 230° C., and held for 30 minutes; and then the mixture was further heated to 300° C. and held for 60 minutes, to obtain an oleylamine/dioctylamine dispersion of InP/ZnSe quantum dots with an InP core and ZnSe shell. After cooling the obtained dispersion to 240° C., 7.54 g of zinc oleate, 7.54 g of trioctylphosphine, and 4.35 g of trioctylphosphine sulfide were injected in the dispersion and held for 90 minutes, obtaining an oleylamine/dioctylamine dispersion of multi-shell type quantum dots with an InP core and layered ZnSe and ZnS shell.

After cooling the obtained dispersion to room temperature, 50 g of acetone was added to the dispersion and stirred, and the InP/ZnSe/ZnS quantum dots were collected as precipitates with centrifugation. The collected InP/ZnSe/ZnS quantum dots were suspended in 8.67 g of toluene to obtain a toluene dispersion of the InP/ZnSe/ZnS quantum dots. To this dispersion, 50 g of acetone was further added and stirred, and the InP/ZnSe/ZnS quantum dots were collected as precipitates with centrifugation. The collected InP/ZnSe/ZnS quantum dots were suspended in 7.03 g of octane to obtain an octane dispersion of purified InP/ZnSe/ZnS quantum dots. The results of measuring the emission properties of the resulting dispersion are shown in Table 1.

### [Synthesis Example 3] Synthesis of Red InP/ZnSe/ZnS Quantum Dots

To 14.25 g of 1-octadecene, 1.59 g of indium myristate was added, and the mixture was heated to 120° C. while stirring under reduced pressure and degassed for 1.5 hours. After degassing, the pressure was returned to atmospheric pressure using nitrogen gas, and the mixture was cooled to 40° C. to obtain a 1-octadecene solution of indium myristate.

In the state that the obtained 1-octadecene solution of indium myristate was held at 40° C. under a nitrogen atmosphere, 2.51 g of trioctylphosphine solution containing 10% by mass of tris(trimethylsilyl)phosphine was added, and held for 10 minutes, to allow it to cool naturally to 20° C. Thereby a yellow liquid containing an InP quantum dot precursor was obtained.

Then, by heating the InP quantum dot precursor solution to 280° C., the InP quantum dot reaction solution, which would serve as the base, was obtained.

In a separate reaction vessel, 2.39 g of indium myristate was added to 21.37 g of 1-octadecen, and the mixture was heated to 120° C. while stirring under reduced pressure and degassed for 1.5 hours. After degassing, the pressure was returned to atmospheric pressure using nitrogen gas, and the mixture was cooled to 40° C. to obtain a 1-octadecen solution of indium myristate.

In the state that the obtained 1-octadecen solution of indium myristate was held at 40° C. under a nitrogen atmosphere, 3.76 g of trioctylphosphine solution containing 10% by mass of tris(trimethylsilyl)phosphine was added, and held for 10 minutes, to allow it to cool naturally to 20° C. Thereby a yellow liquid containing an InP quantum dot precursor was obtained.

The previously prepared InP quantum dot reaction solution, which would serve as the base, was reheated to 260° C., and then a newly prepared InP quantum dot precursor solution was added over a period of 60 minutes to obtain an InP quantum dot reaction solution.

In a 200 mL reaction vessel, 7.54 g of zinc oleate, 4.09 g of zinc chloride, 5.40 g of trioctylphosphine selenide, 8.90 g of trioctylphosphine, 16.26 g of oleylamine, and 16.26 g of dioctylamine were mixed, and heated to 120° C. while stirring under reduced pressure and degassed for 30 minutes. After degassing, the pressure was returned to atmospheric pressure using nitrogen gas, and the mixture was heated to 180° C. under a nitrogen atmosphere; to the mixture, 15.29 g of the previously obtained InP quantum dot reaction solution was added, heated to 230° C., and held for 30 minutes; and then the mixture was further heated to 300° C. and held for 60 minutes, to obtain an oleylamine/dioctylamine dispersion of InP/ZnSe quantum dots with an InP core and ZnSe shell. After cooling the obtained dispersion to 240° C., 7.54 g of zinc oleate, 7.54 g of trioctylphosphine, and 4.35 g of trioctylphosphine sulfide were injected in the dispersion and held for 90 minutes, obtaining an oleylamine/dioctylamine dispersion of multi-shell type quantum dots with an InP core and layered ZnSe and ZnS shell.

After cooling the obtained dispersion to room temperature, 50 g of acetone was added to the dispersion and stirred, and the InP/ZnSe/ZnS quantum dots were collected as precipitates with centrifugation. The collected InP/ZnSe/ZnS quantum dots were suspended in 8.67 g of toluene to obtain a toluene dispersion of the InP/ZnSe/ZnS quantum dots. To this dispersion, 50 g of acetone was further added and stirred, and the InP/ZnSe/ZnS quantum dots were collected as precipitates with centrifugation. The collected InP/ZnSe/ZnS quantum dots were suspended in 7.03 g of octane to obtain an octane dispersion of purified InP/ZnSe/ZnS quantum dots. The results of measuring the emission properties of the resulting dispersion are shown in Table 1.

### Example 1

### (Ligand Exchange Step)

To a 50-mL two-necked round-bottom flask, 2 mL of the octan dispersion of green InP/ZnSe/ZnS quantum dots obtained in Synthesis Example 1 (quantum dots concentration: 0.100 mmol/mL) and 10 mL of hexadecane were measured. Under reduced pressure, the mixture was heated to 90° C. while stirring and degassed for 30 minutes. After degassing, the pressure was returned to atmospheric pressure using nitrogen gas, and the mixture was heated to 220° C. under a nitrogen atmosphere; and 4 mL of 3-mercaptopropionic acid was added to the mixture and held for 10 minutes, to obtain InP/ZnSe/ZnS quantum dots with ligands replaced by 3-mercaptopropionic acid. After cooling the mixture to 160° C., 40 mL of octane was added, and cooled to room temperature. A supernatant was removed from the mixture, and 30 mL of hexane was added and stirred, and then a supernatant was removed again. This was repeated three times to obtain a solid. This solid was suspended in 5 mL of ethanol, and the InP/ZnSe/ZnS quantum dots were collected as precipitates with centrifugation.

### (Dispersion Step)

After dispersing the collected InP/ZnSe/ZnS quantum dots by adding 3.6 mL of 40% aqueous solution of tetraethylammonium hydroxide, 6 mL of tetrahydrofuran and 60 mL of 2-propanol were added and stirred, and the InP/ZnSe/ZnS quantum dots were collected as precipitates with centrifugation. After dispersing the collected InP/ZnSe/ZnS quantum dots by adding 1.6 mL of pure water, 60 mL of 2-propanol was added and stirred, and the InP/ZnSe/ZnS quantum dots were collected as precipitates with centrifugation. This was repeated twice, and the obtained precipitates were dispersed in 10 mL of pure water, obtaining an aqueous dispersion of purified InP/ZnSe/ZnS quantum dots.

### (Surface Treatment Step)

To a glass flask with stopper, 3 mL of the InP/ZnSe/ZnS quantum dot aqueous dispersion (quantum dot concentration: 0.020 mmol/mL), 0.082 g of anhydrous zinc chloride, and 5 mL of pure water were measured. After reducing the pressure, the atmosphere was returned to atmospheric pressure using nitrogen gas to create a nitrogen atmosphere; and the mixture was heated to an internal temperature between 80° C. and 100° C. while stirring, held for 30 minutes, and cooled to room temperature, obtaining a surface-treated InP/ZnSe/ZnS quantum dot aqueous dispersion.

### (Shell Formation Step)

To the obtained surface-treated InP/ZnSe/ZnS quantum dot aqueous dispersion, 0.090 g of anhydrous zinc chloride dissolved in 4.0 mL of pure water and 1.0 mL of 3-mercaptopropionic acid were added. After reducing the pressure, the atmosphere was returned to atmospheric pressure using nitrogen gas to create a nitrogen atmosphere; then the mixture was heated to an internal temperature between 80° C. and 100° C. while stirring, held for 30 minutes, and cooled to room temperature, obtaining a water-soluble InP/ZnSe/ZnS quantum dot aqueous dispersion.

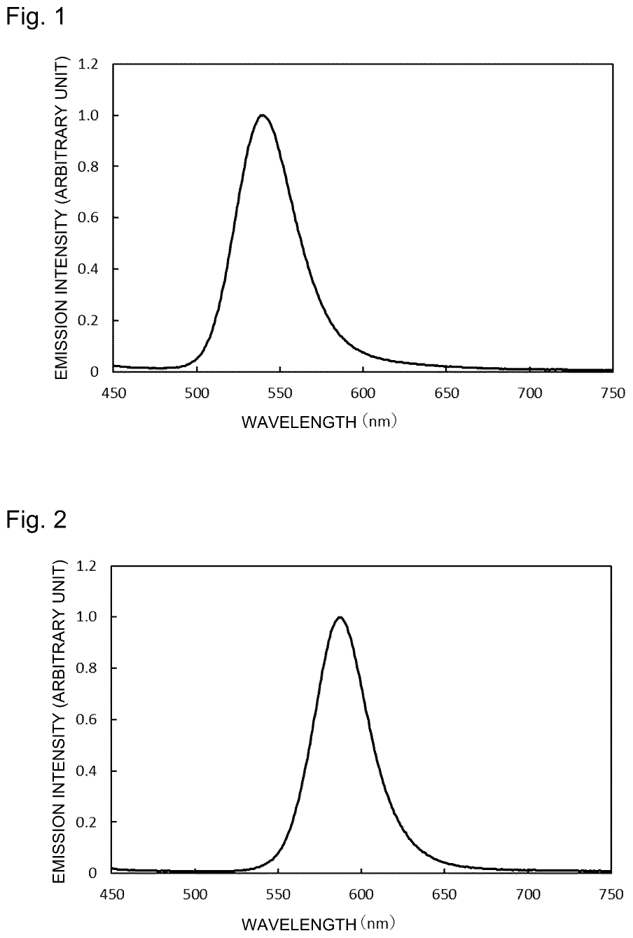

The obtained water-soluble InP/ZnSe/ZnS quantum dot aqueous dispersion was centrifuged to collect water-soluble InP/ZnSe/ZnS quantum dots as precipitates. After dispersing the collected precipitates by adding 2.25 mL of pure water and 0.10 mL of 35% aqueous solution of tetraethylammonium hydroxide, insoluble impurities were removed with centrifugation, obtaining an aqueous dispersion of purified water-soluble InP/ZnSe/ZnS quantum dots. The results of measuring the emission properties of the resulting aqueous dispersion are shown in Table 1. Furthermore, the result of measuring the emission spectrum of the resulting aqueous dispersion is shown in FIG. 1.

### Example 2

An aqueous dispersion of purified water-soluble InP/ZnSe/ZnS quantum dots was obtained in the same manner as in Example 1, except that the octane dispersion of orange InP/ZnSe/ZnS quantum dots obtained in Synthesis Example 2 was used in the ligand exchange step. The results of measuring the emission properties of the resulting aqueous dispersion are shown in Table 1. Furthermore, the result of measuring the emission spectrum of the resulting aqueous dispersion is shown in FIG. 2.

### Example 3

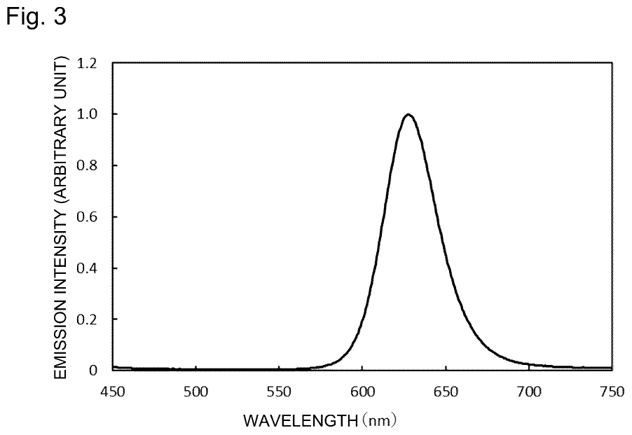

An aqueous dispersion of purified water-soluble InP/ZnSe/ZnS quantum dots was obtained in the same manner as in Example 1, except that the octane dispersion of red InP/ZnSe/ZnS quantum dots obtained in Synthesis Example 3 was used in the ligand exchange step. The results of measuring the emission properties of the resulting aqueous dispersion are shown in Table 1. Furthermore, the result of measuring the emission spectrum of the resulting aqueous dispersion is shown in FIG. 3.

### Example 4

An aqueous dispersion of InP/ZnSe/ZnS quantum dots was obtained in the same manner as in Example 1 until the dispersion step, except that the octane dispersion of red InP/ZnSe/ZnS quantum dots obtained in Synthesis Example 3 was used in the ligand exchange step.

### (Surface Treatment Step)

In 0.60 mL of pure water, 0.12 g of anhydrous zinc chloride was dissolved to obtain an anhydrous zinc chloride aqueous solution. In a glass flask with stopper, 0.05 mL of this anhydrous zinc chloride aqueous solution, 2.0 mL of γ-butyrolactone, and 0.03 mL of the InP/ZnSe/ZnS quantum dot aqueous dispersion (quantum dot concentration: 0.025 mmol/mL) were measured. After reducing the pressure, the atmosphere was returned to atmospheric pressure using nitrogen gas to create a nitrogen atmosphere; then the mixture was heated to an internal temperature between 80° C. and 100° C. while stirring, held for 30 minutes, and cooled to room temperature, obtaining a surface-treated InP/ZnSe/ZnS quantum dot aqueous dispersion.

### (Shell Formation Step)

To the obtained surface-treated InP/ZnSe/ZnS quantum dot aqueous dispersion, 0.05 mL of anhydrous zinc chloride aqueous solution and 0.02 mL of 3-mercaptopropionic acid were added. After reducing the pressure, the atmosphere was returned to atmospheric pressure using nitrogen gas to create a nitrogen atmosphere; then the mixture was heated to an internal temperature between 190° C. and 205° C. while stirring, held for 30 minutes, and cooled to room temperature, obtaining a water-soluble InP/ZnSe/ZnS quantum dot aqueous dispersion.

The obtained water-soluble InP/ZnSe/ZnS quantum dot aqueous dispersion was centrifuged to collect water-soluble InP/ZnSe/ZnS quantum dots as precipitates. After dispersing the collected precipitates by adding 1.0 mL of pure water and 0.1 mL of 35% tetraethylammonium hydroxide aqueous solution, insoluble impurities were removed with centrifugation, obtaining an aqueous dispersion of purified water-soluble InP/ZnSe/ZnS quantum dots. The results of measuring the emission properties of the resulting aqueous dispersion are shown in Table 1.

### Example 5

An aqueous dispersion of InP/ZnSe/ZnS quantum dots was obtained in the same manner as in Example 1 until the dispersion step, except that the octane dispersion of orange InP/ZnSe/ZnS quantum dots obtained in Synthesis Example 2 was used in the ligand exchange step.

### (Surface Treatment Step)

To 2.0 mL of pure water, 0.044 g of zinc acetate dihydrate was dissolved to obtain a zinc acetate aqueous solution. In a glass flask with stopper, 1.0 mL of this zinc acetate aqueous solution, 5.0 mL of pure water, and 0.5 mL of InP/ZnSe/ZnS quantum dot aqueous dispersion (quantum dot concentration: 0.020 mmol/mL) were measured. After reducing the pressure, the atmosphere was returned to atmospheric pressure using nitrogen gas to create a nitrogen atmosphere; then the mixture was heated to an internal temperature between 80° C. and 100° C. while stirring, held for 30 minutes, and cooled to room temperature, obtaining a surface-treated InP/ZnSe/ZnS quantum dot aqueous dispersion.

### (Shell Formation Step)

To the obtained surface-treated InP/ZnSe/ZnS quantum dot aqueous dispersion, 1.0 mL of zinc acetate aqueous solution and 0.16 mL of 3-mercaptopropionic acid were added. After reducing the pressure, the atmosphere was returned to atmospheric pressure using nitrogen gas to create a nitrogen atmosphere; then the mixture was heated to an internal temperature between 80° C. and 100° C. while stirring, held for 30 minutes, and cooled to room temperature, obtaining a water-soluble InP/ZnSe/ZnS quantum dot aqueous dispersion.

The obtained water-soluble InP/ZnSe/ZnS quantum dot aqueous dispersion was centrifuged to collect water-soluble InP/ZnSe/ZnS quantum dots as precipitates. After dispersing the collected precipitates by adding 0.30 mL of pure water and 0.03 mL of 35% tetraethylammonium hydroxide aqueous solution, insoluble impurities were removed with centrifugation, obtaining an aqueous dispersion of purified water-soluble InP/ZnSe/ZnS quantum dots. The results of measuring the emission properties of the resulting aqueous dispersion are shown in Table 1.

### Comparative Example 1

With respect to the aqueous dispersion of purified InP/ZnSe/ZnS quantum dots obtained in the dispersion step of Example 1, the results of measuring the emission properties as the water-soluble quantum dots are shown in Table 1.

### Comparative Example 2

With respect to the aqueous dispersion of purified InP/ZnSe/ZnS quantum dots obtained in the dispersion step of Example 2, the results of measuring the emission properties as the water-soluble quantum dots are shown in Table 1.

### Comparative Example 3

With respect to the aqueous dispersion of purified InP/ZnSe/ZnS quantum dots obtained in the dispersion step of Example 3, the results of measuring the emission properties as the water-soluble quantum dots are shown in Table 1.

### Comparative Example 4

The InP/ZnSe/ZnS quantum dots were collected as precipitates by centrifuging 0.5 mL of the octane dispersion of orange InP/ZnSe/ZnS quantum dots obtained in Synthesis Example 3 (quantum dot concentration: 0.020 mmol/mL). The collected InP/ZnSe/ZnS quantum dots were dispersed in 1 mL of n-hexane to create an n-hexane dispersion of InP/ZnSe/ZnS quantum dots (quantum dot concentration: 10 mg/mL).

In a single-neck flask, 1 mL of the obtained dispersion was placed under a nitrogen atmosphere, and 1 mL of 28% ammonia solution, 0.5 mL of 1-butanol, and 0.25 mL of mercaptopropionic acid were added; then the mixture was heated to an internal temperature between 55° C. and 65° C. while stirring; after cooling, 7.5 mL of acetonitrile was added to the mixture, which was then centrifuged; and the obtained solid was dispersed in 1.5 mL of pure water to obtain a mixed dispersion of InP/ZnSe/ZnS quantum dots.

To the obtained mixed dispersion of InP/ZnSe/ZnS quantum dots, 1 mL of Zn-mercaptopropionic acid aqueous solution prepared by mixing 0.14 g of anhydrous zinc chloride, 1 mL of mercaptopropionic acid, and 4 mL of pure water, was added; then the mixture was heated to an internal temperature between 70° C. and 80° C. while stirring, and irradiated with ultraviolet light (wavelength 365 nm) for 40 minutes while stirring. After stopping the irradiation, the reaction solution was cooled to room temperature after 1 hour had passed from the start of stirring; then an operation, in which 4.5 mL of acetonitrile was further added and centrifuged, was performed twice; and the obtained solid was dispersed in 1 mL of pure water to obtain a water-soluble InP/ZnSe/ZnS quantum dot aqueous dispersion. The results of measuring the emission properties of the resulting aqueous dispersion are shown in Table 1.

TABLE 1

| | | | | | Quantum | Maintenance |
|---|---|---|---|---|---|---|
| | Maximum | Type of | | Full Width at | Yield | Value of |
| | Fluorescence | Reaction | Color of | Half Maximum | (PLQY | Quantum |
| | Wavelength | Solvent | Dispersion | (FWHM Value) | Value) | Yield |
| Synthesis | 539 nm | — | Green | 41 nm | 73% | — |
| Example 1 | | | | | | |
| Synthesis | 585 nm | — | Orange | 38 nm | 79% | — |
| Example 2 | | | | | | |
| Synthesis | 624 nm | — | Red | 38 nm | 84% | — |
| Example 3 | | | | | | |
| Example 1 | 540 nm | Water | Green | 42 nm | 64% | 0.88 |
| Example 2 | 587 nm | Water | Orange | 37 nm | 67% | 0.85 |
| Example 3 | 628 nm | Water | Red | 38 nm | 69% | 0.82 |
| Example 4 | 627 nm | GBL | Red | 38 nm | 70% | 0.83 |
| Example 5 | 586 nm | Water | Orange | 38 nm | 69% | 0.87 |
| Comparative | 540 nm | Water | Green | 42 nm | 55% | 0.75 |
| Example 1 | | | | | | |
| Comparative | 586 nm | Water | Orange | 42 nm | 49% | 0.62 |
| Example 2 | | | | | | |
| Comparative | 628 nm | Water | Red | 38 nm | 36% | 0.43 |
| Example 3 | | | | | | |
| Comparative | 586 nm | Water | Orange | 37 nm | 63% | 0.80 |
| Example 4 | | | | | | |

GBL: γ-Butyrolactone

As shown in Table 1, it was observed that the water-soluble quantum dots obtained using the method of the present invention exhibit a FWHM equivalent to that of the hydrophobic quantum dot of the raw material, and the decrease in quantum yield is also suppressed.

1. A method for producing water-soluble quantum dots, the method comprising:
a ligand exchange step of adding hydrophilic ligands to a hydrophobic quantum dot dispersion to exchange ligands bound to surfaces of quantum dots with the hydrophilic ligands, thereby obtaining hydrophilic quantum dots;
a dispersion step of dispersing the hydrophilic quantum dots in an aqueous solvent to obtain an aqueous solvent dispersion of the hydrophilic quantum dots;
a surface treatment step of adding a surface treatment agent to the aqueous solvent dispersion to perform surface treatment of the hydrophilic quantum dots in the aqueous solvent, thereby obtaining an aqueous solvent dispersion of surface-treated hydrophilic quantum dots; and
a shell formation step of adding a shell-forming agent to the aqueous solvent dispersion of surface-treated hydrophilic quantum dots to form shells on the surfaces of the surface-treated hydrophilic quantum dots, thereby obtaining an aqueous solvent dispersion of water-soluble quantum dots.

2. The method for producing water-soluble quantum dots according to claim 1, wherein the quantum dots in the hydrophobic quantum dot dispersion are quantum dots having a core-shell structure in which the core includes an InP-based quantum dot obtained by reaction of at least a phosphorus source and an indium source, and in which the shell includes a coating compound other than an InP-based compound.

3. The method for producing water-soluble quantum dots according to claim 1, wherein the shell is at least one selected from the group consisting of AlN, AlP, Al₂O₃, GaN, GaP, Ga₂O₃, SiO₂, CdS, CdSe, CdSeS, CdTe, CdSeTe, CdTeS, ZnS, ZnSe, ZnSeS, ZnTe, ZnSeTe, ZnTeS, ZnO, ZnOS, ZnSeO, and ZnTeO.

4. The method for producing water-soluble quantum dots according to claim 1, wherein the hydrophilic ligands used in the ligand exchange step are at least one selected from the group consisting of thiols, amine-containing thiols, amines, alcohols, thiol-containing alcohols, selenols, phosphites, phosphinic acids, phosphonic acids, phosphoric acids, phosphine oxides, phosphine sulfides, phosphine selenides, carboxylic acids, thiol-containing carboxylic acids, thio-carboxylic acids, thiono-carboxylic acids, dithio-carboxylic acids, sulfenic acids, sulfinic acids, and sulfonic acids.

5. The method for producing water-soluble quantum dots according to claim 1, wherein the aqueous solvent is water.

6. The method for producing water-soluble quantum dots according to claim 1, wherein the surface treatment agent is a metal halide, a metal carboxylate, a hydrogen halide, a nitrogen halide, a halide of quaternary ammonium or quaternary phosphonium compounds, or a carboxylic acid, a phosphonic acid, a sulfonic acid, or an acid halide thereof.

7. The method for producing water-soluble quantum dots according to claim 1, wherein the shell-forming agent is a mixture of: at least one sulfur source selected from the group consisting of thiols, thiol-containing carboxylic acids, thioureas, thiocarbamates, thiocarbonates, thiocarboxylic acids, thionocarboxylic acids, dithiocarboxylic acids, phosphine sulfides, and sulfides of Li, Na, K, Be, Mg, Ca, and Sr; and zinc carboxylate, zinc nitrate, zinc sulfate, zinc hypochlorite, zinc chlorite, zinc chlorate, zinc perchlorate, zinc bromate, zinc iodate, zinc carbonate, zinc borate, zinc hypophosphite, zinc phosphite, zinc phosphate, zinc trifluoromethanesulfonate, or a halide of zinc.

8. Water-soluble quantum dots, wherein quantum yield of the water-soluble quantum dots obtained by replacing ligands bound to surfaces of hydrophobic quantum dots with hydrophilic ligands is more than 0.8 with respect to quantum yield of the hydrophobic quantum dots.

9. The water-soluble quantum dots according to claim 8, which are quantum dots having a core-shell structure in which the core includes an InP-based quantum dot composed of at least a phosphorous element and an indium element, and in which the shell includes a coating compound other than the InP-based compound.

10. The water-soluble quantum dots according to claim 9, wherein the shell comprises at least one selected from the group consisting of AlN, AlP, Al₂O₃, GaN, GaP, Ga₂O₃, SiO₂, CdS, CdSe, CdSeS, CdTe, CdSeTe, CdTeS, ZnS, ZnSe, ZnSeS, ZnTe, ZnSeTe, ZnTeS, ZnO, ZnOS, ZnSeO, or ZnTeO.

11. The water-soluble quantum dots according to claim 8, wherein the ligands coordinating to the surfaces of the water-soluble quantum dots are at least one selected from the group consisting of thiols, amine-containing thiols, amines, alcohols, thiol-containing alcohols, selenols, phosphites, phosphinic acids, phosphonic acids, phosphoric acids, phosphine oxides, phosphine sulfides, phosphine selenides, carboxylic acids, thiol-containing carboxylic acids, thio-carboxylic acids, thiono-carboxylic acids, dithio-carboxylic acids, sulfenic acids, sulfinic acids, and sulfonic acids.

12. The method for producing water-soluble quantum dots according to claim 2, wherein the shell is at least one selected from the group consisting of AlN, AlP, Al₂O₃, GaN, GaP, Ga₂O₃, SiO₂, CdS, CdSe, CdSeS, CdTe, CdSeTe, CdTeS, ZnS, ZnSe, ZnSeS, ZnTe, ZnSeTe, ZnTeS, ZnO, ZnOS, ZnSeO, and ZnTeO.

13. The method for producing water-soluble quantum dots according to claim 2, wherein the hydrophilic ligands used in the ligand exchange step are at least one selected from the group consisting of thiols, amine-containing thiols, amines, alcohols, thiol-containing alcohols, selenols, phosphites, phosphinic acids, phosphonic acids, phosphoric acids, phosphine oxides, phosphine sulfides, phosphine selenides, carboxylic acids, thiol-containing carboxylic acids, thio-carboxylic acids, thiono-carboxylic acids, dithio-carboxylic acids, sulfenic acids, sulfinic acids, and sulfonic acids.

14. The method for producing water-soluble quantum dots according to claim 2, wherein the aqueous solvent is water.

15. The method for producing water-soluble quantum dots according to claim 2, wherein the surface treatment agent is a metal halide, a metal carboxylate, a hydrogen halide, a nitrogen halide, a halide of quaternary ammonium or quaternary phosphonium compounds, or a carboxylic acid, a phosphonic acid, a sulfonic acid, or an acid halide thereof.

16. The method for producing water-soluble quantum dots according to claim 2, wherein the shell-forming agent is a mixture of: at least one sulfur source selected from the group consisting of thiols, thiol-containing carboxylic acids, thioureas, thiocarbamates, thiocarbonates, thiocarboxylic acids, thionocarboxylic acids, dithiocarboxylic acids, phosphine sulfides, and sulfides of Li, Na, K, Be, Mg, Ca, and Sr; and zinc carboxylate, zinc nitrate, zinc sulfate, zinc hypochlorite, zinc chlorite, zinc chlorate, zinc perchlorate, zinc bromate, zinc iodate, zinc carbonate, zinc borate, zinc hypophosphite, zinc phosphite, zinc phosphate, zinc trifluoromethanesulfonate, or a halide of zinc.

17. The water-soluble quantum dots according to claim 9, wherein the ligands coordinating to the surfaces of the water-soluble quantum dots are at least one selected from the group consisting of thiols, amine-containing thiols, amines, alcohols, thiol-containing alcohols, selenols, phosphites, phosphinic acids, phosphonic acids, phosphoric acids, phosphine oxides, phosphine sulfides, phosphine selenides, carboxylic acids, thiol-containing carboxylic acids, thio-carboxylic acids, thiono-carboxylic acids, dithio-carboxylic acids, sulfenic acids, sulfinic acids, and sulfonic acids.
